(19) United States
(12) Patent Application Publication
(10) Pub. No.: US 2026/0073212 A1
(43) Pub. Date: Mar. 12, 2026

(54) HYBRID FORWARD-BACKWARD MODEL TRAINING

(71) Applicant: QUALCOMM Incorporated, San Diego, CA (US)

(72) Inventors: Junmin WU, San Diego, CA (US); Jamie Menjay LIN, San Diego, CA (US); Scott Benjamin LEASK, San Diego, CA (US); Khalid TAHBOUB, San Diego, CA (US); Kai WANG, San Diego, CA (US)

(21) Appl. No.: 18/830,306

(22) Filed: Sep. 10, 2024

(51) Int. Cl. G06N 3/08

(52) U.S. Cl. CPC G06N 3/08

(57) ABSTRACT

Systems and techniques are described for model training. In some aspects, a computing device can determine a batch list indicating a sequence of trainings for each step of a plurality of steps for training network parameters of a neural network model, wherein the sequence of trainings comprises at least one of one or more backward trainings or one or more forward trainings. The computing device can train, according to the batch list, the network parameters of the neural network model. In some aspects, a computing device can determine a backward gradient based on performing backward training of network parameters of a neural network model and can determine, based on the backward gradient, a scale for forward training of the network parameters of the neural network model. The computing device can apply the scale to the network parameters for forward training of the network parameters of the neural network model.

### FIELD

The present disclosure generally relates to model training. For example, aspects of the present disclosure relate to hybrid forward-backward model training.

### BACKGROUND

Many devices and systems can obtain data (e.g., image frames or video), such as from their environment (e.g., including a scene). In some cases, the data can be processed for performing one or more functions, can be output for display, can be output for processing and/or consumption by other devices, among other uses.

An artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. In some examples, convolutional neural networks are able to extract high-level features, such as facial shapes, from an input image, and use these high-level features to output a probability that, for example, an input image includes a particular object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for model training. In some aspects, an apparatus of neural network model training is provided. The apparatus includes at least one memory and at least one processor coupled to the at least one memory and configured to: determine a batch list indicating a sequence of trainings for each step of a plurality of steps for training network parameters of a neural network model, wherein the sequence of trainings includes at least one of one or more backward trainings or one or more forward trainings; and train, according to the batch list, the network parameters of the neural network model.

In some aspects, a method of neural network model training at a device is provided. The method includes: determining a batch list indicating a sequence of trainings for each step of a plurality of steps for training network parameters of a neural network model, wherein the sequence of trainings includes at least one of one or more backward trainings or one or more forward trainings; and training, according to the batch list, the network parameters of the neural network model.

In some aspects, a non-transitory computer-readable medium is provided having stored thereon instructions that, when executed by at least one processor, cause the at least one processor to: determine the triggered event causes a current loss for training the neural network model to be higher than a threshold loss value; and include backward trainings in the batch list based on determining the triggered event causes the current loss for training the neural network model to be higher than the threshold loss value.

In some aspects, an apparatus of neural network model training is provided. The apparatus includes: means for determining a batch list indicating a sequence of trainings for each step of a plurality of steps for training network parameters of a neural network model, wherein the sequence of trainings includes at least one of one or more backward trainings or one or more forward trainings; and means for training, according to the batch list, the network parameters of the neural network model.

In some aspects, an apparatus of neural network model training is provided. The apparatus includes at least one memory and at least one processor coupled to the at least one memory and configured to: determine a backward gradient based on performing backward training of network parameters of a neural network model; determine, based on the backward gradient, a scale for forward training of the network parameters of the neural network model; and apply the scale to the network parameters for forward training of the network parameters of the neural network model.

In some aspects, a method of neural network model training at a device is provided. The method includes: determining a backward gradient based on performing backward training of network parameters of a neural network model; determining, based on the backward gradient, a scale for forward training of the network parameters of the neural network model; and applying the scale to the network parameters for forward training of the network parameters of the neural network model.

In some aspects, a non-transitory computer-readable medium is provided having stored thereon instructions that, when executed by at least one processor, cause the at least one processor to: determine a backward gradient based on performing backward training of network parameters of a neural network model; determine, based on the backward gradient, a scale for forward training of the network parameters of the neural network model; and apply the scale to the network parameters for forward training of the network parameters of the neural network model.

In some aspects, an apparatus of neural network model training is provided. The apparatus includes: means for determining a backward gradient based on performing backward training of network parameters of a neural network model; means for determining, based on the backward gradient, a scale for forward training of the network parameters of the neural network model; and means for applying the scale to the network parameters for forward training of the network parameters of the neural network model.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor (or multiple processors) configured to perform one or more operations of any of the methods summarized above. In some cases, the processor(s) can include a neural processing unit (NPU), a neural signal processor (NSP), a digital signal processor (DSP), a graphics processing unit (GPU), a central processing unit (CPU), any combination thereof, and/or other processor(s). Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example extended-reality (XR) system, in accordance with some aspects of the disclosure.

FIG. 2 is a block diagram illustrating an example of a deep learning network, in accordance with some aspects of the disclosure.

FIG. 3 is a block diagram illustrating an example of a convolutional neural network, in accordance with some aspects of the disclosure.

FIG. 4 is a diagram illustrating an example of feed-forward training, in accordance with some aspects of the disclosure.

FIG. 5 is a diagram illustrating an example of a process for a forward-backward cross-momentum (FBCM) approach, in accordance with some aspects of the disclosure.

FIG. 6 is graph illustrating examples of different gradients, in accordance with some aspects of the disclosure.

FIG. 7 is a flow diagram illustrating an example of a process for model training, in accordance with some aspects of the disclosure.

FIG. 8 is a flow diagram illustrating another example of a process for model training, in accordance with some aspects of the disclosure.

FIG. 9 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As noted above, machine learning systems or models (e.g., deep neural network systems or models) can be used to perform a variety of tasks such as, for example and without limitation, detection and/or recognition (e.g., scene or object detection and/or recognition, face detection and/or recognition, etc.), depth estimation, pose estimation, image reconstruction, classification, three-dimensional (3D) modeling, dense regression tasks, data compression and/or decompression, and image processing, among other tasks. Machine learning systems or models can be versatile and can achieve high quality results in a variety of tasks.

In some examples, a machine learning system or model can include a feed-forward neural network. A feed-forward neural network is characterized by the direction of the flow of information between layers of the network. The flow is unidirectional, where the information in the model flows in only one direction, the forward direction, from the input nodes (e.g., through hidden nodes) to the output nodes, without any cycles or loops.

In machine learning, backpropagation (e.g., which may be referred to as backward training) can be performed to train a machine learning model or system (e.g., a neural network). Backpropagation is a gradient estimation method used for updating neural network parameters of neural networks during training. For example, backpropagation can be used to compute the gradient of a loss function with respect to weights of the network for a single input-output example, computing the gradient one layer at a time, iterating from the last layer. Another form of machine learning model or system training is feed-forward training or forward training. Feed-forward training makes use of two forward passes, one with positive data and another with negative data.

A computing device, such as an edge device or other device (e.g., which may be or may include a system on a chip (SOC)) can include one or more processors that can be utilized to train a machine learning model or system (e.g., a neural network) and/or to run interference of the machine learning model or system. The processor(s) can include one or more neural processing units (NPUs), neural signal processors (NSPs), digital signal processors (DSPs), graphics processing unit (GPUs), central processing unit (CPUs), any combination thereof, and/or other processor(s). Some computing devices (e.g., edge devices) may have limited resources to support on-device backward training (e.g., backpropagation). For example, on-device processing by certain processors (e.g., CPU and GPU) are able to conduct only a limited number of backward propagation passes. For example, such processors often perform multiple tasks (other than machine learning model/system training) and, as such, cannot provide all available resources for machine learning model/system training. Training for such processors can also require a large power budget for the associated device with the processors. Although certain processors designed for neural network processing (e.g., NPUs, NSPs, etc.) include computational resources for machine learning models/systems (e.g., neural networks), such neural network processors may not have an ability to perform backward training. Further, certain computing devices (e.g., edge devices) have limited memory and thus cannot perform complex backward training with their processors, such as CPUs and GPUs (e.g., due to intermediate tensor/gradient tracking).

Feed-forward training is a plausible alternative to backward propagation. However, feedforward training can have a number of issues. For example, for current feed-forward training methods, satisfactory convergence cannot be achieved due to the lack of gradient magnitudes. Feed-forward training is a zero-order optimization method, where the final convergence results may be worse than when using backward training (e.g., due to backward training being a first order training method), for example as seen for video post processing, such as with three-dimensional Gaussian splatting (3DGS). Feed-forward training methods are sensitive to exploding and vanishing gradients, when not using optimal model parameter initialization. A feed-forward scale value (e.g., a noise scale), employed within feed-forward training, requires much trial and error to choose, and can easily explode and vanish during the early training iterations.

As such, improved systems and techniques for model training on an edge device can be beneficial.

In one or more aspects of the present disclosure, systems, apparatuses, methods (also referred to as processes), and computer-readable media (collectively referred to herein as “systems and techniques”) are described herein that provide solutions for hybrid forward-backward model training. In some cases, the hybrid forward-backward model training can be performed with cross momentums (e.g., for an edge device processor, such as an NPU, NSP, DSP, CPU, GPU, etc.).

Various aspects relate generally to model training. Some aspects more specifically relate to systems and techniques that provide solutions for a forward and backward switch method (e.g., for switching between forward and backward training) and/or for a forward-backward cross momentum (FBCM) approach. For example, the FBCM approach can use information from the backward training to guide the forward training process. In one or more examples, the solutions can employ certain processors (e.g., NPUs, NSPs, etc.) for the training. The systems and techniques described herein allow for high-quality on-device training. In one or more examples, the solutions make forward training resilient to initialization of model parameters (e.g., weights, biases, etc.). In some cases, the forward gradient magnitude (e.g., of the FBCM approach) is meaningful as compared to using a pure forward training method.

In one or more aspects, during operation of a method of neural network model training at a device, one or more processors of the device can determine, from backward training of network parameters of a neural network, a backward gradient. The backward gradient can then be used for forward training of the network parameters. For example, the one or more processors can determine, based on the backward gradient, a scale value (e.g., a noise scale) for forward training of the network parameters of the neural network. The one or more processors can apply the scale value to the network parameters for forward training of the network parameters of the neural network model.

In one or more examples, determining the scale value (e.g., the noise scale) can include determining a norm based on the backward gradient and a latest norm (e.g., a latest norm value). A norm can be determined using a function applied to the backward gradient. In some examples, the function can be an absolute value of the gradient values, a square of the gradient values, or other function. In some cases, the one or more processors of the device can obtain (e.g., read, retrieve, receive, etc.) the latest norm from a norm storage (e.g., a norm buffer or other storage). In one or more examples, the one or more processors can store the norm in the norm storage. In some examples, the scale value (e.g., the noise scale) can be inversely proportional to the norm. In one or more examples, the device can be an edge device. In some examples, the edge device can be a system on a chip (SOC).

In some examples, during operation of a method of neural network model training at a device, one or more processors of the device can determine a batch list indicating a sequence of trainings for each step of a plurality of steps for training network parameters of a neural network. In one or more examples, the sequence of trainings can include one or more backward trainings and/or one or more forward trainings. The one or more processors can train, according to the batch list, the parameters of the neural network.

In one or more examples, the batch list can be statically defined prior to the training or dynamically defined during the training. In some examples, when the batch list is statically defined prior to the training, the batch list can be based on a percentage of the forward trainings or on a percentage of the backward trainings. In one or more examples, when the batch list is statically defined prior to the training, the batch list can be based on an exponential decay function for a decay parameter for a percentage of the forward trainings or for a percentage of the backward trainings.

In some examples, when the batch list is dynamically defined during the training, the batch list can be based on an amount of computational resources that are available. In one or more examples, the computational resources can include one or more central processing units (CPUs), one or more graphics processing units (GPUs), and/or one or more neural processing units (NPUs). In some examples, when at least one or more of the CPUs or one or more of the GPUs have available resources, the batch list can be defined to include backward trainings. In one or more examples, when at least one or more of the NPUs have available resources, the batch list can be defined to include forward trainings.

In one or more examples, when the batch list is dynamically defined during the training, the batch list can be based on a current loss for training the neural network. In some examples, when the current loss is higher than a threshold loss value, the batch list can be defined to include backward trainings. In one or more examples, when the current loss is less than or equal to a threshold loss value, the batch list can be defined to include forward trainings.

In some examples, when the batch list is dynamically defined during the training, the batch list can be based on a triggered event. In one or more examples, when the triggered event causes a current loss for training the neural network to be higher than a threshold loss value, the batch list can be defined to include backward trainings.

Particular aspects of the subject matter described in this disclosure can be implemented to realize one or more of the following potential advantages. For example, the systems and techniques can provide the benefit of being able to run on an NPU (e.g., whereas, conversely, backward training alone cannot be run on an NPU). The systems and techniques can also provide the benefit of providing for better training convergency and quality, as compared to forward training.

Additional aspects of the present disclosure are described in more detail below.

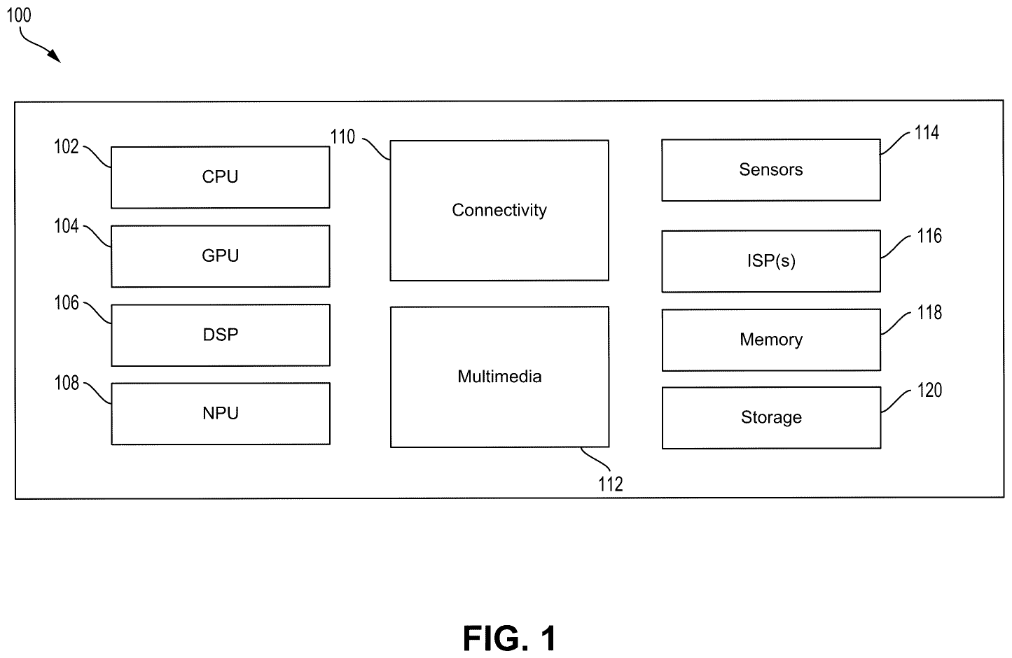

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include one or more sensors 114, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform image processing using machine learning techniques according to aspects of the present disclosure discussed herein. For example, SOC 100 and/or components thereof may be configured to perform disparity estimation refinement for pairs of images (e.g., stereo image pairs, each including a left image and a right image). SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding the output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

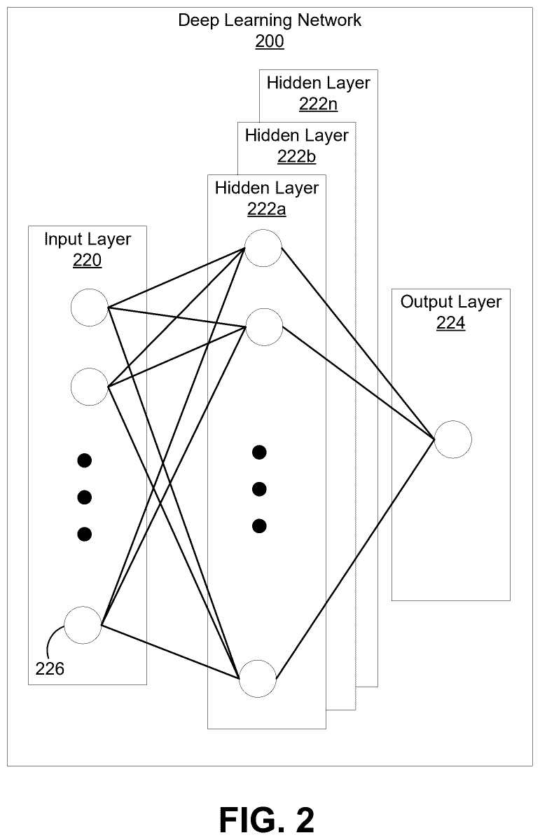

FIG. 2 is an illustrative example of a deep learning neural network 200 that can be used by the machine learning model. An input layer 220 includes input data. In some examples, the input layer 220 can include data representing the pixels of an input video frame. The neural network 200 includes multiple hidden layers 222a, 222b, through 222n. The hidden layers 222a, 222b, through 222n include “n” number of hidden layers, where “n” is an integer greater than or equal to one. The number of hidden layers can be made to include as many layers as needed for the given application. The neural network 200 further includes an output layer 224 that provides an output resulting from the processing performed by the hidden layers 222a, 222b, through 222n. In some examples, the output layer 224 can provide a classification for an object in an input video frame. The classification can include a class identifying the type of object (e.g., a person, a dog, a cat, or other object).

The neural network 200 is a multi-layer neural network of interconnected nodes. Each node can represent a piece of information. Information associated with the nodes is shared among the different layers and each layer retains information as information is processed. In some cases, the neural network 200 can include a feed-forward network, in which case there are no feedback connections where outputs of the network are fed back into itself. In some cases, the neural network 200 can include a recurrent neural network, which can have loops that allow information to be carried across nodes while reading in input.

Information can be exchanged between nodes through node-to-node interconnections between the various layers. Nodes of the input layer 220 can activate a set of nodes in the first hidden layer 222a. For example, as shown, each of the input nodes of the input layer 220 is connected to each of the nodes of the first hidden layer 222a. The nodes of the hidden layers 222a, 222b, through 222n can transform the information of each input node by applying activation functions to the information. The information derived from the transformation can then be passed to and can activate the nodes of the next hidden layer 222b, which can perform their own designated functions. Example functions include convolutional, up-sampling, data transformation, and/or any other suitable functions. The output of the hidden layer 222b can then activate nodes of the next hidden layer, and so on. The output of the last hidden layer 222n can activate one or more nodes of the output layer 224, at which an output is provided. In some cases, while nodes (e.g., node 226) in the neural network 200 are shown as having multiple output lines, a node has a single output and all lines shown as being output from a node represent the same output value.

In some cases, each node or interconnection between nodes can have a weight that is a set of parameters derived from the training of the neural network 200. Once the neural network 200 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 200 to be adaptive to inputs and able to learn as more and more data is processed.

The neural network 200 is pre-trained to process the features from the data in the input layer 220 using the different hidden layers 222a, 222b, through 222n in order to provide the output through the output layer 224. In an example in which the neural network 200 is used to identify objects in images, the neural network 200 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 200 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 200 is trained well enough so that the weights of the layers are accurately tuned.

For the example of identifying objects in images, the forward pass can include passing a training image through the neural network 200. The weights are initially randomized before the neural network 200 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 200, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 200 is unable to determine low level features and thus cannot make an accurate determination of what the classification of the object might be. A loss function can be used to analyze error in the output. Any suitable loss function definition can be used. An example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 200 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denote the initial weight, and η denotes a learning rate. The learning rate can be set to any suitable value, with a high learning rate including larger weight updates and a lower value indicating smaller weight updates.

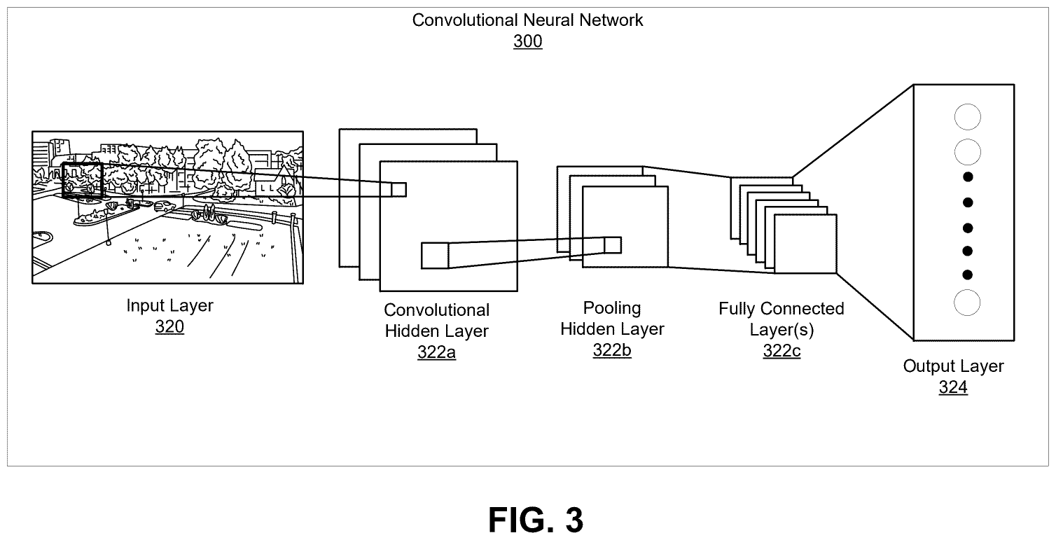

The neural network 200 can include any suitable deep network. As described previously, an example of a neural network 200 includes a convolutional neural network (CNN), which includes an input layer and an output layer, with multiple hidden layers between the input and out layers. An example of a CNN is described below with respect to FIG. 3. The hidden layers of a CNN include a series of convolutional, nonlinear, pooling (for downsampling), and fully connected layers. The neural network 200 can include any other deep network other than a CNN, such as an autoencoder, a deep belief nets (DBNs), a Recurrent Neural Networks (RNNs), among others.

FIG. 3 is an illustrative example of a convolutional neural network 300 (CNN 300). The input layer 320 of the CNN 300 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 322a, an optional non-linear activation layer, a pooling hidden layer 322b, and fully connected hidden layers 322c to get an output at the output layer 324. While only one of each hidden layer is shown in FIG. 3, one of ordinary skill will appreciate that multiple convolutional hidden layers, non-linear layers, pooling hidden layers, and/or fully connected layers can be included in the CNN 300. As previously described, the output can indicate a single class of an object or can include a probability of classes that best describe the object in the image.

The first layer of the CNN 300 is the convolutional hidden layer 322a. The convolutional hidden layer 322a analyzes the image data of the input layer 320. Each node of the convolutional hidden layer 322a is connected to a region of nodes (pixels) of the input image called a receptive field. The convolutional hidden layer 322a can be considered as one or more filters (each filter corresponding to a different activation or feature map), with each convolutional iteration of a filter being a node or neuron of the convolutional hidden layer 322a. For example, the region of the input image that a filter covers at each convolutional iteration would be the receptive field for the filter. In some examples, if the input image includes a 28×28 array, and each filter (and corresponding receptive field) is a 5×5 array, then there will be 24×24 nodes in the convolutional hidden layer 322a. Each connection between a node and a receptive field for that node learns a weight and, in some cases, an overall bias such that each node learns to analyze its particular local receptive field in the input image. Each node of the hidden layer 322a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 322a is due to each node of the convolutional layer being applied to its corresponding receptive field. For example, a filter of the convolutional hidden layer 322a can begin in the top-left corner of the input image array and can convolve around the input image. As noted above, each convolutional iteration of the filter can be considered a node or neuron of the convolutional hidden layer 322a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 322a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 322a.

The mapping from the input layer to the convolutional hidden layer 322a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 322a can include several activation maps in order to identify multiple features in an image. The example shown in FIG. 3 includes three activation maps. Using three activation maps, the convolutional hidden layer 322a can detect three different kinds of features, with each feature being detectable across the entire image.

In some examples, a non-linear hidden layer can be applied after the convolutional hidden layer 322a. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 300 without affecting the receptive fields of the convolutional hidden layer 322a.

The pooling hidden layer 322b can be applied after the convolutional hidden layer 322a (and after the non-linear hidden layer when used). The pooling hidden layer 322b is used to simplify the information in the output from the convolutional hidden layer 322a. For example, the pooling hidden layer 322b can take each activation map output from the convolutional hidden layer 322a and generates a condensed activation map (or feature map) using a pooling function. Max-pooling is an example of a function performed by a pooling hidden layer. Other forms of pooling functions be used by the pooling hidden layer 322a, such as average pooling, L2-norm pooling, or other suitable pooling functions. A pooling function (e.g., a max-pooling filter, an L2-norm filter, or other suitable pooling filter) is applied to each activation map included in the convolutional hidden layer 322a. In the example shown in FIG. 3, three pooling filters are used for the three activation maps in the convolutional hidden layer 322a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 322a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 322a having a dimension of 24×24 nodes, the output from the pooling hidden layer 322b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. The positional information can be discarded without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 300.

The final layer of connections in the network is a fully-connected layer that connects every node from the pooling hidden layer 322b to every one of the output nodes in the output layer 324. Using the example above, the input layer includes 28×28 nodes encoding the pixel intensities of the input image, the convolutional hidden layer 322a includes 3×24×24 hidden feature nodes based on application of a 5×5 local receptive field (for the filters) to three activation maps, and the pooling layer 322b includes a layer of 3×12×12 hidden feature nodes based on application of max-pooling filter to 2×2 regions across each of the three feature maps. Extending the example, the output layer 324 can include ten output nodes. In such an example, every node of the 3×12×12 pooling hidden layer 322b is connected to every node of the output layer 324.

The fully connected layer 322c can obtain the output of the previous pooling layer 322b (which should represent the activation maps of high-level features) and determines the features that most correlate to a particular class. For example, the fully connected layer 322c layer can determine the high-level features that most strongly correlate to a particular class, and can include weights (nodes) for the high-level features. A product can be computed between the weights of the fully connected layer 322c and the pooling hidden layer 322b to obtain probabilities for the different classes. For example, if the CNN 300 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 324 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some examples, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

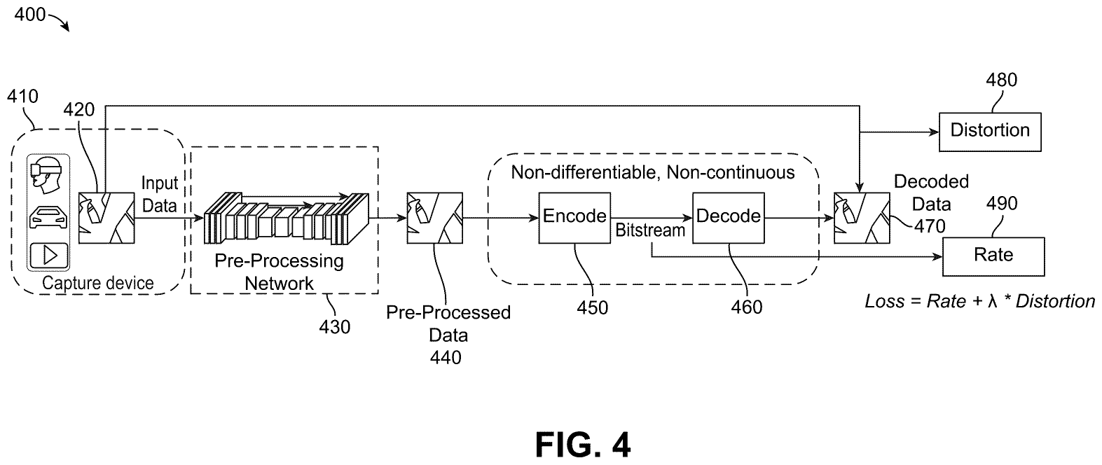

A feed-forward neural network has a flow of information between layers of the network that is in the forward direction, which flows from the input nodes (e.g., through hidden nodes) to the output nodes. As noted previously, feed-forward neural network may be trained using feed-forward training (e.g., forward training). FIG. 4 is a diagram illustrating an example of feed-forward training (e.g., forward training) of a feed-forward network 400. In FIG. 4, the feed-forward network 400 is shown to include a pre-processing network 430, an encoder 450, and a decoder 460. The pre-processing network 430 may include a plurality of layers, where each of the layers may have a respective weight (e.g., a previously trained weight).

In FIG. 4, during operation of forward training of the feed-forward network 400, one or more processors of the feed-forward network 400 can generate, for each network parameter of a plurality of network parameters, a random Gaussian noise vₜ (e.g., with a zero mean and a standard variance) with a dimension equal to the respective associated network parameter. In one or more examples, the plurality of network parameters (e.g., which may also be referred to as training parameters) are the weights of the layers of the pre-processing network 430. The one or more processors of the feed-forward network 400 can then add each of the generated random Gaussian noise vₜ values to its associated network parameter.

Input data 420 (e.g., an image), which may be captured by a capture device 410 (e.g., a camera, such as within XR glasses or a vehicle), may be inputted into the pre-processing network 430. The pre-processing network 430 may be run for a first pass to produce, based on the input data 420, pre-processed data 440 (e.g., output_data_1). The pre-processed data 440 (e.g., output_data_1) may be input into the encoder 450. The encoder 450 can be run (e.g., run a codec, such as H.264) to produce (e.g., encode), based on the pre-processed data 440 (e.g., output_data_1), a bitstream (e.g., bitstream 1). The bitstream (e.g., bitstream 1) can be input into the decoder 460. The decoder 460 can be run to produce (e.g., decode), based on the bitstream (e.g., bitstream 1), the decoded data 470 (e.g., reconstructed data 1).

The one or more processors of the feed-forward network 400 may determine a rate (e.g., rate 1) 490 from the bitstream (e.g., bitstream 1). The one or more processors of the feed-forward network 400 may determine a distortion 480 (e.g., based on the difference) between the input data 420 and the decoded data 470 (e.g., reconstructed data 1). The one or more processors of the feed-forward network 400 can then determine (e.g., calculate) a positive loss, which is equal to:

$${1}_{+} = rate 1 + λ ⋆ MSE ( input data 420 , reconstructed data 1 )$$

where MSE is the mean squared error, and λ is a constant.

The one or more processors of the feed-forward network 400 can then subtract two times each of the generated random Gaussian noise vₜ values (e.g., 2 vₜ) from its associated network parameter, which will result in each of the network parameters being less than their respective random Gaussian noise vₜ. The pre-processing network 430 may be run for a second pass to produce, based on the input data 420, pre-processed data 440 (e.g., output_data_2). The pre-processed data 440 (e.g., output_data_2) may be input into the encoder 450. The encoder 450 can be run (e.g., run a codec, such as H.264) to produce (e.g., encode), based on the pre-processed data 440 (e.g., output_data_2), a bitstream (e.g., bitstream 2). The bitstream (e.g., bitstream 2) can be input into the decoder 460. The decoder 460 can be run to produce (e.g., decode), based on the bitstream (e.g., bitstream 2), the decoded data 470 (e.g., reconstructed data 2).

The one or more processors of the feed-forward network 400 may determine a rate (e.g., rate 2) 490 from the bitstream (e.g., bitstream 2). The one or more processors of the feed-forward network 400 may determine a distortion 480 (e.g., based on the difference) between the input data 420 and the decoded data 470 (e.g., reconstructed data 2). The one or more processors of the feed-forward network 400 can then determine (e.g., calculate) a negative loss, which is equal to:

$${1}_{-} = rate 1 + λ ⋆ MSE ( input data 420 , reconstructed data 2 )$$

The one or more processors of the feed-forward network 400 may determine, for each parameter, a gradient gₜ, which can be found by:

$${d}_{t} = sign ( \frac{{l}_{+} - {l}_{-}}{{v}_{t}} )$$

$${g}_{t} ← \vert {v}_{t} \vert {d}_{t}$$

The one or more processors of the feed-forward network 400 can then restore the network parameters by adding each of the generated random Gaussian noise vₜ values to its associated network parameter. The one or more processors of the feed-forward network 400 can then update the network parameters by the gradient descents by:

$${θ}_{t + 1} = {θ}_{t} - η {g}_{t}$$

where η is a constant, and θ is a network parameter.

In one or more examples, the previously described process may be run several times (e.g., until it converges) in order to obtain improved gradients.

In one or more aspects, the systems and techniques provide hybrid forward-backward model training with cross momentums for an edge neural processor. In one or more examples, the systems and techniques provide solutions for a forward and backward switch method as well as for a forward-backward cross momentum (FBCM) approach (e.g., which uses information from the backward training to guide the forward training process).

In one or more aspects, for the forward and backward switch method, a static switch method or a dynamic switch method may be employed.

In some aspects, for the static switch method, a predefined fixed list (e.g., a static list for a batch) for switching between forward trainings and backward trainings (e.g., F . . . B . . . F . . . ) can be defined for each step of a batch that is run. The number of steps can indicate how many times a batch is run for training (e.g., when there are five steps, the batch is run for each of the five steps). In one or more examples, based on the given number of iterations (e.g., steps) to run a batch and a batch size (e.g., a number of forward and backward trainings within the batch), a static list for a batch that switches between forward training and backward training can be defined. For example, with a step size of five and a batch size of ten, a static list of (BBFFFFFFFF), which contains a total of ten trainings (e.g., for the batch size of ten) including two backward trainings followed by eight forward trainings, for a batch can be run consecutively five times (e.g., five steps). In one or more examples, for a given batch size that is greater than one, one or more forward trainings and/or one or more backward trainings may be included within a static list for a batch. In some examples, a static list of a batch may include only one or more forward trainings or one or more backward trainings.

In one or more examples, for the forward and backward switch method employing a static list, an example of pseudocode is as follows:

```
Definitions: F represents forward training, and B represents backward training;
Inputs: a static list L [B...F...],...[B...F...]] is input for each training step, where L is
S x N dimensions, S is the number of training steps, and N is the batch size;
for i in S:
  forward_num=0; forward_gradient=0; backward_gradient=0
  for j in N:
  if L[i][j]==B:
    do backward training and get current_gradient;
    backward_gradient+=current_gradient
  else
    forward_num++
    do forward training and get current_gradient;
    forward_gradient+=current_ gradient;
  forward_gradient/=forward_num;
  backward_gradient/=(N-forward_num)
  //different learning rates can be used for the forward and backward gradients,
  also, we can use the same learning rate
  Network_parameter=Current_network_parameter-
  backward_learning_rate*backward_ gradient
  Network_parameter=Current_network_parameter-
  forward_learning_rate*forward_gradient
```

As shown in the algorithm of the pseudocode, at the beginning of the algorithm, the forward number (e.g., forward_num) is defined as zero, the forward gradient (e.g., forward_gradient) is defined as zero, and the backward gradient (e.g., backward_gradient) is defined as zero. The algorithm then checks if the list L reads “B” for backward training or “F” for forward training. If the list L reads “B” for backward training, then the algorithm will perform backward training and obtain the current gradient (e.g., current_gradient). The algorithm will set the backward gradient (e.g., backward_gradient) to be equal to the prior backward gradient (if any) plus the current gradient.

However, if the list L reads “F” for forward training, then the algorithm will perform forward training and obtain the current gradient (e.g., current_gradient). The algorithm will set the forward gradient (e.g., forward_gradient) to be equal to the prior forward gradient (if any) plus the current gradient.

The algorithm will then determine the forward gradient (e.g., forward_gradient) to be equal to the average forward gradient, which is equal to the latest forward gradient divided by the forward number (e.g., forward_num). The algorithm will also determine the backward gradient (e.g., backward gradient) to be equal to the average backward gradient, which is equal to the latest backward gradient divided by N minus the forward number (forward_num).

The algorithm will then set a network parameter (e.g., network_parameter) for the backward training to be equal to the current network parameter (e.g., current_network_parameter) minus a backward learning rate (e.g., backward_learning_rate) times the backward gradient (e.g., backward_gradient). The algorithm will then set a network parameter (e.g., network_parameter) for the forward training to be equal to the current network parameter (e.g., current_network_parameter) minus a forward learning rate (e.g., forward_learning_rate) times the forward gradient (e.g., forward_gradient).

For an example for a better understanding of the algorithm, S may be equal to 5 steps, N may be equal to 10 for the batch size, L may be equal to [BBFFFFFFFF] that contains a total of 10 trainings, the backward learning rate may be equal to 1e-4 (e.g., 1*10⁻⁴), and the forward learning rate may be equal to 5e-5 (e.g., 5*10⁻⁵). In one or more examples, the forward learning rate may be smaller than the backward learning rate, since backward training is more stable than forward training.

During operation of the algorithm, the batch specified by the list L [BBFFFFFFFF] may be run consecutively five times (e.g., five steps). After the batch [BBFFFFFFFF] is run five times, the cumulative forward gradient and the cumulative backward gradient can be determined. The average forward gradient and the average backward gradient can then be determined, based on the cumulative forward gradient and the cumulative backward gradient. The network parameter (e.g., network_parameter) for the backward training can then be determined, based on the backward learning rate and the average backward gradient, and the network parameter (e.g., network_parameter) for the forward training can then be determined, based on the forward learning rate and the average forward gradient.

In one or more examples, a static list may be defined based on a percentage of forward trainings and backward trainings. For example, when given ten percent of backward trainings, for every one-hundred trainings, ten steps of backward trainings can be performed and ninety steps of forward trainings can be performed.

In some examples, a static list may be defined based on an exponential decay function for a decay parameter for a percentage of forward trainings and backward trainings. Since in earlier training stages, forward training is not stable, but in later training stages, it is easier for the forward training to converge; larger percentages of backward training can be utilized in the early training stages and can be decayed to forward training in the later training stages.

In one or more examples, for a method to define a static list based on an exponential decay function for a percentage of forward trainings and backward trainings, an example of pseudocode is as follows:

```
Inputs: initialize number N1 (e.g., 20), a decay parameter a (e.g., 0.99), and an empty
list L
for steps in total_steps:
  if steps%100==0:
    N1=N1*a
    if N1>100:
      N1=100
  if steps%100<N1:
    append(B) to the list L
  else
    append(F) to the list L
  return list L
```

As shown in the algorithm of the pseudocode, at the beginning of the algorithm, N1 is set to 20. For every 100 steps, “a” is decayed. For the 100 steps, the list L is appended with backward training for the first 20 steps. After the first 20 steps, the backward training is decayed by the decay parameter “a” (e.g., 0.99) to forward training for the remaining steps.

In some aspects, for the dynamic switch method, the list, including forward and backward trainings, can change dynamically during the training. In one or more examples, for the forward and backward switch method employing a dynamic list, an example of pseudocode is as follows:

```
Definitions: F represents forward training, and B represents backward training;
Inputs: S is the number of training steps, and N is the batch size;
for i in S:
  forward_num=0; forward_gradient=0; backward_gradient=0
  for j in N:
    Decide the type B or F
    if type==B:
      do backward training and get current_gradient;
      backward_gradient+=current_gradient
    else
      forward_num++
      do forward training and get current_gradient;
      forward_gradient+=current_ gradient;
  forward_gradient/=forward_num;
  backward_gradient/=(N-forward_num)
  //different learning rates can be used for the forward and backward gradients,
  also, we can use the same learning rate
  Network_parameter=Current_network_parameter-
  backward_learning_rate*backward_ gradient
  Network_parameter=Current_network_parameter-
  forward_learning_rate*forward_gradient
```

As shown in the algorithm of the pseudocode, the algorithm employing the dynamic list is similar to the algorithm employing a static list, except that the algorithm employing the dynamic list decides whether the type is B for backward training or F for forward training. In one or more examples, for a given batch size that is greater than one, one or more forward trainings and/or one or more backward trainings may be included within a dynamic list for a batch. In some examples, a dynamic list of a batch may include only one or more forward trainings or one or more backward trainings.

In one or more examples, the list can be dynamically changed based on computational resources, loss, event triggers, and/or learning rates. For example, the percentage of backward trainings and/or forward trainings may be based on an amount of computational resources that are available. For example, one or more CPUs, GPUs, and/or NPUs may be allocated for backward and/or forward trainings at any time when computational resources are available. In some examples, several batches may be run on one or more CPUs, GPUs, and/or NPUs based on availability, and their performance can be tested to decide a percentage of forward and backward trainings to be run on the one or more CPUs, GPUs, and/or NPUs. For example, when at least one or more CPUs or one or more GPUs have available resources, the batch list can be defined to include backward trainings. For another example, when at least one or more NPUs have available resources, the batch list can be defined to include forward trainings.

For another example, the percentage of backward trainings and/or forward trainings may be based on the current loss for training. For example, when the loss is high, to increase stability, the list can be dynamically changed to include backward trainings. Conversely, when the loss is small, the list can be dynamically changed to include forward trainings. For example, when the current loss is higher than a threshold loss value, the batch list can be defined to include backward trainings. For another example, when the current loss is less than or equal to the threshold loss value, the batch list can be defined to include forward trainings. Since the loss decays as an exponential function, an exponential function can be fit for the loss. The list can then be dynamically defined based on the exponential decay function for the loss for a percentage of forward trainings and backward trainings.

For yet another example, the type of training in a list can be switched based on the triggering of an event. In one or more examples, when the triggered event causes a current loss for training to be higher than a threshold loss value, the batch list can be defined to include backward trainings. For example, when some pre-defined operation occurs, for example, when a model reset happens for 3DGS, which can cause the loss to increase dramatically, the list can be dynamically changed to include backward trainings for several steps.

In one or more aspects, as previously mentioned, the systems and techniques provide solutions for a forward-backward cross momentum (FBCM) approach, which uses information from the backward training to guide the forward training process. The FBCM approach utilizes a backward gradient to decide a scale value (e.g., a noise scale) to use for the forward training (e.g., to use for vₜ of the forward training of FIG. 4). For example, if the backward gradient is large, a small-scale value will be employed for the forward training. In another example, if the backward gradient is small, a large-scale value will be employed for the forward training.

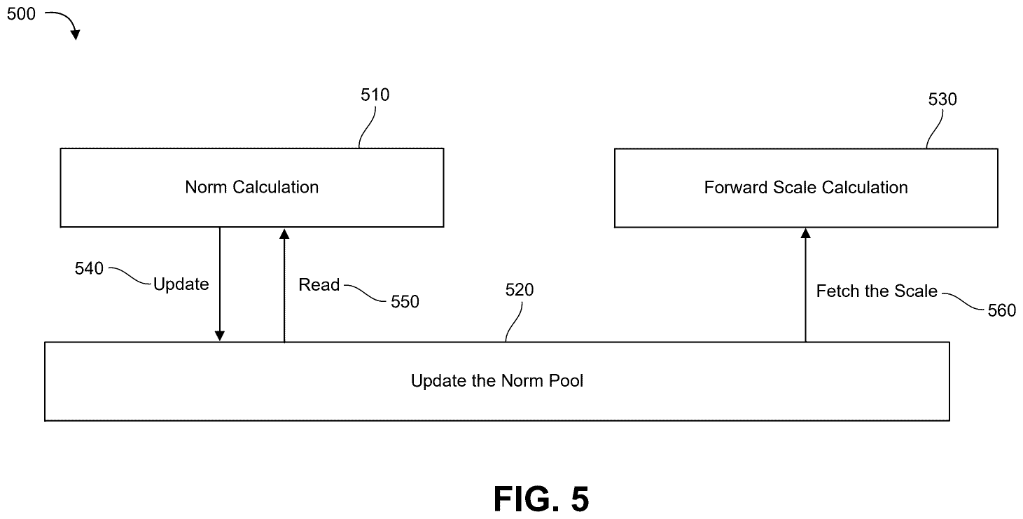

FIG. 5 is a diagram illustrating an example of a process 500 for a forward-backward cross-momentum (FBCM) approach for training a neural network (or other machine learning model or system). During operation of the process 500 for FBCM, one or more processors can perform a norm calculation 510 (e.g., per step) to determine norms. In order to perform the norm calculation 510, the one or more processors may read 550 the latest norm (e.g., a previously determined norm) from a norm storage (e.g., a norm buffer or other storage) that can store a norm pool 520.

The norm pool 520 can include a latest norm (e.g., a previously determined norm or norm value, such as a most recently determined norm) for each parameter (e.g., weight) of one or more layers of the neural network, a latest norm for each layer (referred to as a layer wise norm), a latest norm for each channel of the neural network (referred to as a channel wise norm), and/or at other levels of granularity. The norm in the norm pool 520 can be calculated based on gradients from the backward training. For instance, an input can be denoted as X=[x₁, x₂, x₃], a neural network layer (e.g., a multi-layer perceptron (MLP)) of the neural network can be a 3×3 matrix denoted as L_{NN}=[3×3], and an output of the neural network layer L_{NN} (based on processing X using L_{NN}) can be denoted as Y=[y₁, y₂, y₃]. A gradient of the output Y can be determined as dY/dX, which can be a 3×3 gradient matrix of gradient values (one value for each parameter, such as weight, of the neural network layer L_{NN}). An example of the 3×3 matrix of gradient values is

$$\frac{dY}{dx} = [ \begin{matrix}- 1 & 2 & 3 \\ 2 & 3 & 6 \\ - 3 & 3 & 4\end{matrix} ] .$$

Based on the gradient values, a norm can be determined as 3×3 matrix of norm values. In some examples, the norms can be determined an absolute value of each corresponding gradient value in the gradient matrix (corresponding to a magnitude of the gradient). Using the example 3×3 gradient matrix above, the norm can be determined as

$$norm = [ \begin{matrix}1 & 2 & 3 \\ 2 & 3 & 6 \\ 3 & 3 & 4\end{matrix} ] .$$

In another example, the norm can be determined by squaring each of the gradient values. In some aspects, the norm (e.g., a norm value) stored in the norm pool can be the average of the norm values in the norm matrix norm (e.g., a norm value of 3 in the example above).

In some cases, the one or more processors can obtain the current gradient (e.g., current_gradient) from performing backward training. The one or more processors can then calculate a norm as follows:

$$Norm = α ( abs ( current\_graident ) ) + ( 1 - α ) ( latest norm )$$

where abs(current_gradient) is the current norm, and α is a hyper parameter. Using the example from above, if the current gradient from the backward training is a 3×3 matrix and is equal to

$$[ \begin{matrix}- 1 & 2 & 3 \\ 2 & 3 & 6 \\ - 3 & 3 & 4\end{matrix} ] ,$$

then the current norm can be determined as the absolute value of the current gradient from the backward training, which is equal to

$$[ \begin{matrix}1 & 2 & 3 \\ 2 & 3 & 6 \\ 3 & 3 & 4\end{matrix} ] .$$

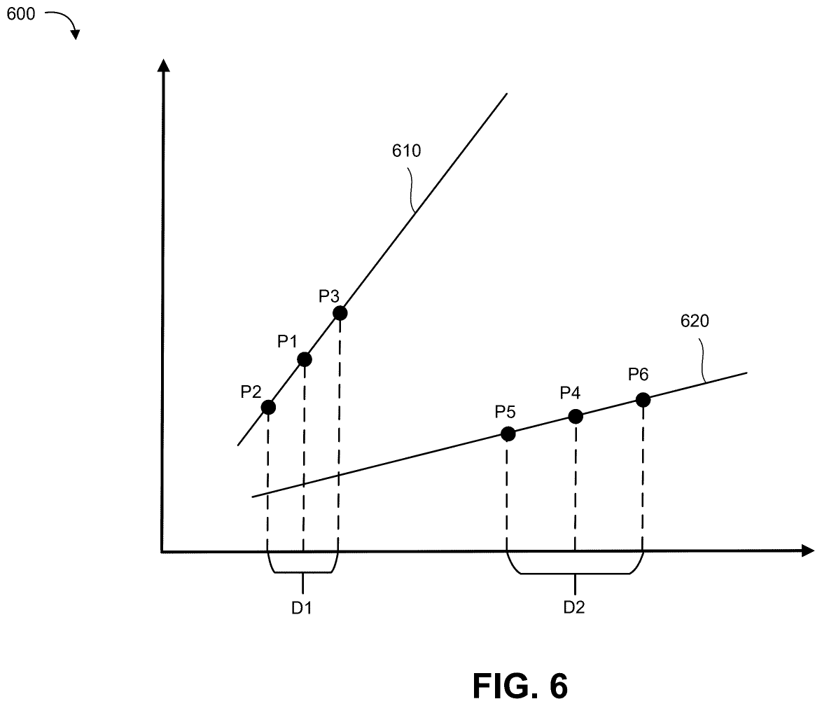

When the magnitude of the gradient is large, the forward training can be perturbed (e.g., indicating how much parameters, such as weights, are modified) by a small step. When the magnitude of the gradient is small, the forward training can be perturbed by a large step. In FIG. 6, graph 600 is illustrating examples of different gradients. In FIG. 6, the graph 600 shows gradients of two different lines with points. In FIG. 6, line 610 with points P1, P2, P3 is shown to have a large slope (e.g., a large gradient), and line 620 with points P4, P5, P6 is shown to have a small slope (e.g., a small gradient). For graph 600, since line 610 has a larger gradient than line 620, the distance D1 between the points P2 and P3 on the line 610 is smaller than the distance D2 between the points P5 and P6 on the line 620. The distances D1 and D2 are proportional to amounts to perturb the trainings.

Referring back to FIG. 5, after the norm is calculated, the one or more processors can store the calculated norm in the norm pool 520 in the norm storage. For example, the one or more processors can update the norm pool 520 by sending an update 540 with the calculated norm to the norm pool 520. After the norm pool is updated, the one or more processors can perform a forward scale calculation 530 by calculating a scale value (e.g., a noise scale) to use for the forward training (e.g., to use for vₜ of the forward training of FIG. 4), which in some cases can be illustrated as follows:

$$scale = β ( \frac{1}{Norm} )$$

where scale is the scale value (e.g., the noise scale), β is a hyper parameter, and Norm is the norm.

After the scale (e.g., the noise scale) is calculated, the one or more processors can, for each forward training step, fetch 560 the scale for that training step from the norm storage (e.g., the norm buffer or other storage). For each forward training step, vₜ of the forward training of FIG. 4 can be replaced with N(0, 1)×scale, where N(0, 1) is equal to Gaussian noise with a zero mean and an identity variance.

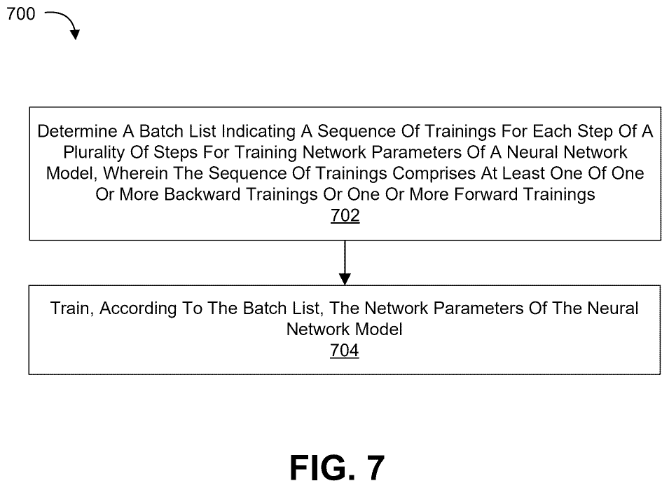

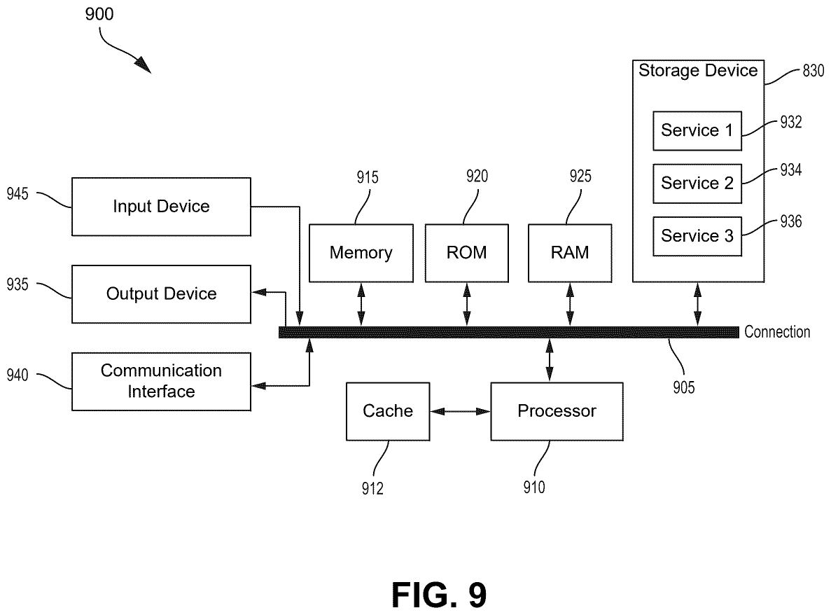

FIG. 7 is a flow chart illustrating an example of a process 700 for model training. The process 700 can be performed by a computing device (e.g., a computing device or computing system 900 of FIG. 9) or by a component or system (e.g., a chipset, one or more processors such as a neural processing unit (NPU), a neural signal processor (NSP), a digital signal processor (DSP), a graphics processing unit (GPU), a central processing unit (CPU), any combination thereof, and/or other processor(s), or other component or system) of the computing device. The operations of the process 700 may be implemented as software components that are executed and run on one or more processors (e.g., processor 910 of FIG. 9, or other processor(s)). Further, the transmission and reception of signals by the computing device in the process 700 may be enabled, for example, by one or more antennas and/or one or more transceivers (e.g., wireless transceiver(s)).

At block 702, the computing device (or component thereof) can determine a batch list indicating a sequence of trainings for each step of a plurality of steps for training network parameters of a neural network model. The sequence of trainings includes at least one of one or more backward trainings or one or more forward trainings.

At block 704, the computing device (or component thereof) can train, according to the batch list, the network parameters of the neural network model.

In some aspects, the batch list is statically defined prior to the training. In some examples, the batch list can be based on a percentage of the one or more forward trainings or on a percentage of the one or more backward trainings. In some cases, the batch list can be based on an exponential decay function for a decay parameter for a percentage of the one or more forward trainings or for a percentage of the one or more backward trainings.

In some aspects, the batch list is dynamically defined during the training. In some cases when the batch list is dynamically defined during training, the batch list can be based on an amount of computational resources that are available (e.g., an amount of resources available from one or more central processing units (CPUs), one or more graphics processing units (GPUs), one or more neural processing units (NPUs), any combination thereof, and/or other computational resources). In some examples, the computing device (or component thereof) can determine at least one of the one or more CPUs or the one or more GPUs have available resources. In such examples, the computing device (or component thereof) can include backward trainings in the batch list based on determining at least one of the one or more CPUs or the one or more GPUs have available resources. In some aspects, the computing device (or component thereof) can determine the one or more NPUs have available resources. In such aspects, the computing device (or component thereof) can include forward trainings in the batch list based on determining the one or more NPUs have available resources. In some cases, the batch list is based on a current loss for training the neural network model. In some

In some cases when the batch list is dynamically defined during training, the computing device (or component thereof) can determine the current loss is higher than a threshold loss value. In such cases, the computing device (or component thereof) can include backward trainings in the batch list based on determining the current loss is higher than the threshold loss value. In some examples when the batch list is dynamically defined during training, the computing device (or component thereof) can determine the current loss is less than or equal to the threshold loss value. In such cases, the computing device (or component thereof) can include forward trainings in the batch list based on determining the current loss is less than or equal to the threshold loss value.

In some cases when the batch list is dynamically defined during training, the batch list is based on a triggered event. In such cases, the computing device (or component thereof) can determine the triggered event causes a current loss for training the neural network model to be higher than a threshold loss value. The computing device (or component thereof) can include backward trainings in the batch list based on determining the triggered event causes the current loss for training the neural network model to be higher than the threshold loss value.

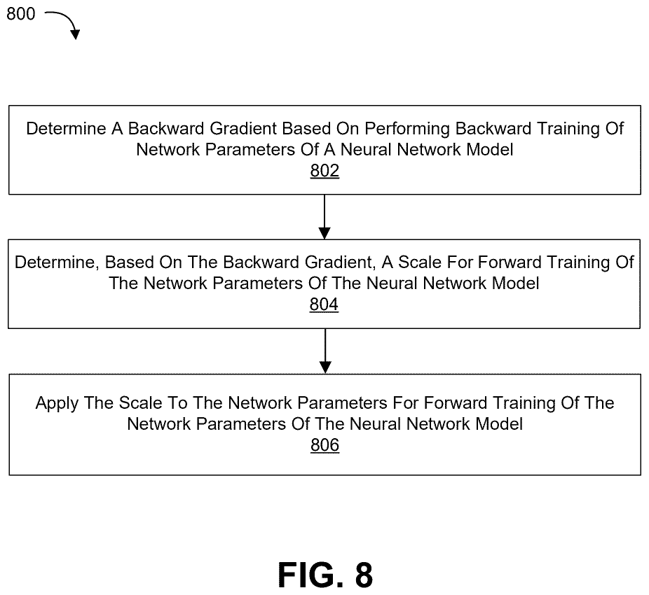

FIG. 8 is a flow chart illustrating an example of a process 800 for model training. The process 800 can be performed by a computing device (e.g., a computing device or computing system 900 of FIG. 9) or by a component or system (e.g., a chipset, one or more processors such as a neural processing unit (NPU), a neural signal processor (NSP), a digital signal processor (DSP), a graphics processing unit (GPU), a central processing unit (CPU), any combination thereof, and/or other processor(s), or other component or system) of the computing device. In some aspects, the computing device can be an edge device including a system on a chip (SOC) or other type of device. The operations of the process 800 may be implemented as software components that are executed and run on one or more processors (e.g., processor 910 of FIG. 9, or other processor(s)). Further, the transmission and reception of signals by the computing device in the process 800 may be enabled, for example, by one or more antennas and/or one or more transceivers (e.g., wireless transceiver(s)).

At block 802, the computing device (or component thereof) can determine a backward gradient based on performing backward training of network parameters of a neural network model.

At block 804, the computing device (or component thereof) can determine, based on the backward gradient, a scale for forward training of the network parameters of the neural network model. In some aspects, the scale is inversely proportional to the norm. In some aspects, to determine the scale, the computing device (or component thereof) can determine a norm based on the backward gradient and a previously determined norm. In some cases, the computing device (or component thereof) can obtain the previously determined norm from a norm storage. In some examples, the computing device (or component thereof) can store the norm in a norm storage.

At block 806, the computing device (or component thereof) can apply the scale to the network parameters for forward training of the network parameters of the neural network model.

In some cases, the computing device of process 700 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 700 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a block diagram illustrating an example of a computing system 900, which may be employed for hybrid forward-backward model training with cross momentums for an edge neural processor. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that communicatively couples various system components including system memory 915, such as read-only memory (ROM) 920 and random-access memory (RAM) 925 to processor 910. Computing system 900 can include a cache 912 of high-speed memory connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900.

Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 940 may also include one or more range sensors (e.g., LiDAR sensors, laser range finders, RF radars, ultrasonic sensors, and infrared (IR) sensors) configured to collect data and provide measurements to processor 910, whereby processor 910 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus of neural network model training, the apparatus comprising: at least one memory; and at least one processor coupled to the at least one memory and configured to: determine a batch list indicating a sequence of trainings for each step of a plurality of steps for training network parameters of a neural network model, wherein the sequence of trainings comprises at least one of one or more backward trainings or one or more forward trainings; and train, according to the batch list, the network parameters of the neural network model.

Aspect 2. The apparatus of Aspect 1, wherein the batch list is statically defined prior to the training.

Aspect 3. The apparatus of Aspect 2, wherein the batch list is based on a percentage of the one or more forward trainings or on a percentage of the one or more backward trainings.

Aspect 4. The apparatus of any of Aspects 2 or 3, wherein the batch list is based on an exponential decay function for a decay parameter for a percentage of the one or more forward trainings or for a percentage of the one or more backward trainings.

Aspect 5. The apparatus of Aspect 1, wherein the batch list is dynamically defined during the training.

Aspect 6. The apparatus of Aspect 5, wherein the batch list is based on an amount of computational resources that are available.

Aspect 7. The apparatus of Aspect 6, wherein the computational resources comprise at least one of one or more central processing units (CPUs), one or more graphics processing units (GPUs), or one or more neural processing units (NPUs).

Aspect 8. The apparatus of Aspect 7, wherein the at least one processor is configured to: determine at least one of the one or more CPUs or the one or more GPUs have available resources; and include backward trainings in the batch list based on determining at least one of the one or more CPUs or the one or more GPUs have available resources.

Aspect 9. The apparatus of any of Aspects 7 or 8, wherein the at least one processor is configured to: determine the one or more NPUs have available resources; and include forward trainings in the batch list based on determining the one or more NPUs have available resources.

Aspect 10. The apparatus of any of Aspects 5 to 9, wherein the batch list is based on a current loss for training the neural network model.

Aspect 11. The apparatus of Aspect 10, wherein the at least one processor is configured to: determine the current loss is higher than a threshold loss value; and include backward trainings in the batch list based on determining the current loss is higher than the threshold loss value.

Aspect 12. The apparatus of Aspect 10, wherein the at least one processor is configured to: determine the current loss is less than or equal to a threshold loss value; and include forward trainings in the batch list based on determining the current loss is less than or equal to the threshold loss value.

Aspect 13. The apparatus of any of Aspects 5 to 12, wherein the batch list is based on a triggered event.

Aspect 14. The apparatus of Aspect 13, wherein the at least one processor is configured to: determine the triggered event causes a current loss for training the neural network model to be higher than a threshold loss value; and include backward trainings in the batch list based on determining the triggered event causes the current loss for training the neural network model to be higher than the threshold loss value.

Aspect 15. A method of neural network model training at a device, the method comprising: determining a batch list indicating a sequence of trainings for each step of a plurality of steps for training network parameters of a neural network model, wherein the sequence of trainings comprises at least one of one or more backward trainings or one or more forward trainings; and training, according to the batch list, the network parameters of the neural network model.

Aspect 16. The method of Aspect 15, wherein the batch list is statically defined prior to the training.

Aspect 17. The method of Aspect 16, wherein the batch list is based on a percentage of the one or more forward trainings or on a percentage of the one or more backward trainings.

Aspect 18. The method of any of Aspects 16 or 17, wherein the batch list is based on an exponential decay function for a decay parameter for a percentage of the one or more forward trainings or for a percentage of the one or more backward trainings.

Aspect 19. The method of any of Aspects 15, wherein the batch list is dynamically defined during the training.

Aspect 20. The method of Aspect 19, wherein the batch list is based on an amount of computational resources that are available.

Aspect 21. The method of Aspect 20, wherein the computational resources comprise at least one of one or more central processing units (CPUs), one or more graphics processing units (GPUs), or one or more neural processing units (NPUs).

Aspect 22. The method of Aspect 21, further comprising: determining at least one of the one or more CPUs or the one or more GPUs have available resources; and including backward trainings in the batch list based on determining at least one of the one or more CPUs or the one or more GPUs have available resources.

Aspect 23. The method of any of Aspects 21 or 22, further comprising: determining the one or more NPUs have available resources; and including forward trainings in the batch list based on determining the one or more NPUs have available resources.

Aspect 24. The method of any of Aspects 19 to 23, wherein the batch list is based on a current loss for training the neural network model.

Aspect 25. The method of Aspect 24, further comprising: determining the current loss is higher than a threshold loss value; and including backward trainings in the batch list based on determining the current loss is higher than the threshold loss value.

Aspect 26. The method of Aspect 24, further comprising: determining the current loss is less than or equal to a threshold loss value; and including forward trainings in the batch list based on determining the current loss is less than or equal to the threshold loss value.

Aspect 27. The method of any of Aspects 19 to 26, wherein the batch list is based on a triggered event.

Aspect 28. The method of Aspect 27, further comprising: determining the triggered event causes a current loss for training the neural network model to be higher than a threshold loss value; and including backward trainings in the batch list based on determining the triggered event causes the current loss for training the neural network model to be higher than the threshold loss value.

Aspect 29. An apparatus of neural network model training, the apparatus comprising: at least one memory; and at least one processor coupled to the at least one memory and configured to: determine a backward gradient based on performing backward training of network parameters of a neural network model; determine, based on the backward gradient, a scale for forward training of the network parameters of the neural network model; and apply the scale to the network parameters for forward training of the network parameters of the neural network model.

Aspect 30. The apparatus of Aspect 29, wherein, to determine the scale, the at least one processor is configured to determine a norm based on the backward gradient and a previously determined norm.

Aspect 31. The apparatus of Aspect 30, wherein the at least one processor is configured to obtain the previously determined norm from a norm storage.

Aspect 32. The apparatus of any of Aspects 30 or 31, wherein the at least one processor is configured to store the norm in a norm storage.

Aspect 33. The apparatus of any of Aspects 30 to 32, wherein the scale is inversely proportional to the norm.

Aspect 34. The apparatus of any of Aspects 29 to 33, wherein the apparatus is an edge device including a system on a chip (SOC).

Aspect 35. A method of neural network model training at a device, the method comprising: determining a backward gradient based on performing backward training of network parameters of a neural network model; determining, based on the backward gradient, a scale for forward training of the network parameters of the neural network model; and applying the scale to the network parameters for forward training of the network parameters of the neural network model.

Aspect 36. The method of Aspect 35, wherein determining the scale comprises determining a norm based on the backward gradient and a previously determined norm.

Aspect 37. The method of Aspect 36, further comprising obtaining the previously determined norm from a norm storage.

Aspect 38. The method of any of Aspects 36 or 37, further comprising storing the norm in a norm storage.

Aspect 39. The method of any of Aspects 36 to 38, wherein the scale is inversely proportional to the norm.

Aspect 40. The method of any of Aspects 35 to 39, wherein the device is an edge device including a system on a chip (SOC).

Aspect 41. A non-transitory computer-readable medium having stored thereon instructions that, when executed by at least one processor, cause the at least one processor to perform operations according to any of Aspects 15 to 28.

Aspect 42. An apparatus for neural network model training, the apparatus including one or more means for performing operations according to any of Aspects 15 to 28.

Aspect 43. A non-transitory computer-readable medium having stored thereon instructions that, when executed by at least one processor, cause the at least one processor to perform operations according to any of Aspects 35 to 40.

Aspect 44. An apparatus for neural network model training, the apparatus including one or more means for performing operations according to any of Aspects 35 to 40.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus of neural network model training, the apparatus comprising:
at least one memory; and
at least one processor coupled to the at least one memory and configured to:
determine a batch list indicating a sequence of trainings for each step of a plurality of steps for training network parameters of a neural network model, wherein the sequence of trainings comprises at least one of one or more backward trainings or one or more forward trainings; and
train, according to the batch list, the network parameters of the neural network model.

2. The apparatus of claim 1, wherein the batch list is statically defined prior to the training.

3. The apparatus of claim 2, wherein the batch list is based on a percentage of the one or more forward trainings or on a percentage of the one or more backward trainings.

4. The apparatus of claim 2, wherein the batch list is based on an exponential decay function for a decay parameter for a percentage of the one or more forward trainings or for a percentage of the one or more backward trainings.

5. The apparatus of claim 1, wherein the batch list is dynamically defined during the training.

6. The apparatus of claim 5, wherein the batch list is based on an amount of computational resources that are available.

7. The apparatus of claim 6, wherein the computational resources comprise at least one of one or more central processing units (CPUs), one or more graphics processing units (GPUs), or one or more neural processing units (NPUs).

8. The apparatus of claim 7, wherein the at least one processor is configured to:
determine at least one of the one or more CPUs or the one or more GPUs have available resources; and
include backward trainings in the batch list based on determining at least one of the one or more CPUs or the one or more GPUs have available resources.

9. The apparatus of claim 7, wherein the at least one processor is configured to:
determine the one or more NPUs have available resources; and
include forward trainings in the batch list based on determining the one or more NPUs have available resources.

10. The apparatus of claim 5, wherein the batch list is based on a current loss for training the neural network model.

11. The apparatus of claim 10, wherein the at least one processor is configured to:
determine the current loss is higher than a threshold loss value; and
include backward trainings in the batch list based on determining the current loss is higher than the threshold loss value.

12. The apparatus of claim 10, wherein the at least one processor is configured to:
determine the current loss is less than or equal to a threshold loss value; and
include forward trainings in the batch list based on determining the current loss is less than or equal to the threshold loss value.

13. The apparatus of claim 5, wherein the batch list is based on a triggered event.

14. The apparatus of claim 13, wherein the at least one processor is configured to:
determine the triggered event causes a current loss for training the neural network model to be higher than a threshold loss value; and
include backward trainings in the batch list based on determining the triggered event causes the current loss for training the neural network model to be higher than the threshold loss value.

15. A method of neural network model training at a device, the method comprising:
determining a batch list indicating a sequence of trainings for each step of a plurality of steps for training network parameters of a neural network model, wherein the sequence of trainings comprises at least one of one or more backward trainings or one or more forward trainings; and
training, according to the batch list, the network parameters of the neural network model.

16. The method of claim 15, wherein the batch list is statically defined prior to the training, and wherein the batch list is based on at least one of:
a percentage of the one or more forward trainings or on a percentage of the one or more backward trainings; or
an exponential decay function for a decay parameter for a percentage of the one or more forward trainings or for a percentage of the one or more backward trainings.

17. The method of claim 15, wherein the batch list is dynamically defined during the training, and wherein the batch list is based on at least one of:
an amount of computational resources that are available;
a current loss for training the neural network model; or
a triggered event.

18. An apparatus of neural network model training, the apparatus comprising:
at least one memory; and
at least one processor coupled to the at least one memory and configured to:
determine a backward gradient based on performing backward training of network parameters of a neural network model;
determine, based on the backward gradient, a scale for forward training of the network parameters of the neural network model; and
apply the scale to the network parameters for forward training of the network parameters of the neural network model.

19. The apparatus of claim 18, wherein, to determine the scale, the at least one processor is configured to determine a norm based on the backward gradient and a previously determined norm.

20. The apparatus of claim 19, wherein the at least one processor is configured to obtain the previously determined norm from a norm storage.
